(19) United States
(12) Patent Application Publication
(10) Pub. No.: US 2001/0025296 A1
(43) Pub. Date: Sep. 27, 2001

(54) Creation of works over a computer network

(76) Inventor: Manoj K. Narang, New York, NY (US)

Correspondence Address: Manoj K. Narang, c/o TRADEWORX, Suite 1010, 304 Park Avenue, South, New York, NY, 10010, US

(21) Appl. No.: 09/784,653

(22) Filed: Feb. 15, 2001

Related U.S. Application Data
(60) Provisional application No. 60/183,717, filed on Feb. 18, 2000.

(51) Int. Cl. G06F 15/16

(52) U.S. Cl. 709/201

(57) ABSTRACT

Methods, apparatuses and systems facilitating the collaborative creation of works over a computer network. The present invention combines, in different ways, elements of improvisation, peer review, incentivization, and centralized process management for the purpose of generating high-quality collaborative works. The present invention can employ an expansive repertoire of collaborative mechanisms. In one embodiment, the key to extracting valuable output from such a collaboration is the implementation of methods that incentivize large-scale participation, and of procedural constraints that allow the process to be managed effectively. In one form, the collaborative process involves awarding participating users based on the quality of their respective critical review.

### RELATED APPLICATIONS

The present application claims the benefit of U.S. Provisional Application No. 60/183,717 filed Feb. 18, 2000 and entitled “Method and Apparatus for Facilitating Collaborative Creation of Works over a Computer Network.”

### FIELD OF THE INVENTION

The present invention relates to tools for collaboration over a computer network and, more particularly, to methods and apparatuses for facilitating and, in some forms of the invention, incentivizing the collaborative creation of works over a computer network.

### BACKGROUND OF THE INVENTION

The Internet represents the latest stage in the evolution of the human urge to collaborate. The World Wide Web, in particular, originated in the desires of physicists to facilitate the sharing of ideas and information. Almost all areas of the scientific community have been quick to embrace the Internet for this purpose, often with astounding results that were difficult to imagine just a few years ago. Foremost among large-scale efforts of human collaboration is the Open Source movement, and its crown jewel, the Linux operating system.

Linux is a mesmerizing story not just because it is a complex, large-scale system designed by hundreds of thousands of contributors around the globe who are typically complete strangers, but because it is superior in most ways to the best commercial alternatives. What makes this truly remarkable is that the army of software engineers who contributed their work to this project had absolutely no direct financial incentive to do so, for Linux is public domain software that can not be sold for a profit. Indubitably, there exist non-financial considerations which motivate people to contribute to the Open Source movement, such as one's standing in the software community. However, that does not explain the quality and coherence of the final product, given the massive number of contributors. The key explanation for this remarkable feat is the high-quality peer review that is made possible by collaboration over the Internet, combined with an overarching process to manage and centralize this collaboration.

In view of the clear potential of Internet-based collaboration and peer review to create superior source code, it is surprising that other kinds of works have yet to be developed in this fashion. An example of a category of a work that stands to benefit from large-scale collaboration is fiction writing. Not only is peer review as important a concept in fiction as it is in source code, but many other facets of collaboration that are familiar to all writers, such as improvisation, are readily reproducible on the Internet as well. Accordingly, the present invention is directed to providing methods and apparatuses for facilitating and, in some embodiments, incentivizing the collaborative creation of works over a computer network, taking advantage of the concepts of peer review, improvisation and other aspects of collaboration.

### SUMMARY OF THE INVENTION

The present invention provides methods, apparatuses and systems facilitating the collaborative creation of works. In one embodiment, the present invention is a collection of components, each involving various techniques, protocols and algorithms, deployed over the Internet or other computer network. The present invention combines, in different ways, elements of improvisation, peer review, incentivization, and centralized process management for the purpose of generating high-quality collaborative works on a recurring basis. The present invention is not limited to a single methodology or a single application, but to a panoply of algorithms that are intimately tied to particular business processes. The present invention can employ an expansive repertoire of collaborative mechanisms. Free-form collaboration over the Internet is already possible. In one embodiment, the key to extracting valuable output from such a collaboration is the implementation of methods that incentivize large-scale participation, and of procedural constraints that allow the process to be managed effectively. In one form, the collaborative process involves rewarding participating users based on the quality of their respective critical review.

The present invention can be used to facilitate and/or incentivize the collaborative development of myriad types of works. For example, the present invention can be used to develop artistic works, such as screenplays, plays, musical scores, and books. The present invention can be used in the fields of product development and marketing. For example and in one embodiment, the present invention can be applied to the development of enhancements to a web site, a software product, and/or a utilitarian article, such as a monitor or even a vacuum cleaner.

Below is a summary of various embodiments of the present invention. In one embodiment, the invention provides methods for facilitating the collaborative creation of a work among members over a computer network. In one embodiment, the method comprises the steps of (a) posting an objective on a server operably connected to the computer network; (b) receiving implementations of the objective from the members; (c) scoring the implementations; (d) selecting the implementation having the greatest score; (e) adding the implementation to the work; and (f) awarding points to at least one member based on the scoring step (c). In one form, the method further comprises (h) eliminating at least one member from further participation in the collaboration based on the total number of points awarded to the respective member(s). In one form, steps (a)-(h) are repeated until the work at issue is completed.

In one embodiment, the objectives are posted as part of a page-based form having standardized fields into which members of the collaboration, using their browsers, enter the desired information. Members then transmit their implementation of the objective as a completed form to a server. In one embodiment, an objective relates to a segment of the work at issue. For example, if the work is a screen play, an objective can be the introduction of a new character or a plot twist.

In one embodiment, implementations are scored through a process of peer review. In one form, the scoring of implementations comprises the steps of (c1) transmitting implementations to at least two of the members; (c2) receiving a ranking of the implementations from each of the members who received the implementations in step (c1); and (c3) aggregating the rankings. In one embodiment, the implementations are distributed among the members for review and scoring. In one form, not all implementations are distributed to all members. Rather and in one embodiment, a predetermined number of implementations is transmitted to a randomly selected group of members. In one form of this embodiment, the number in the group is a predetermined number.

In another embodiment, the implementations submitted by members are also evaluated and scored by a group of evaluators or editors, who manage and retain ultimate control over the collaborative process. In one form, therefore, the method of scoring further comprises the steps of (c4) evaluating, between at least two internal evaluators, the implementations having the highest aggregate ranking calculated in step (c3); (c5) ranking the highest scoring implementations; and (c6) aggregating the rankings of step (c5). In one embodiment, a tie among implementations is resolved by (c7) repeating steps (c5) and (c6) until one implementation is accorded the highest aggregate ranking.

According to one embodiment, members are awarded points for the purposes of determining whether further participation in the collaborative process is allowed for each respective member. In one embodiment, the member having submitted the implementation selected in step (d) is a awarded a predetermined number of points. In one form, the points awarded to such member are equity points. In another embodiment, points are awarded to members based on the performance in ranking implementations relative to all other members. In one embodiment, step (() comprises the step of (f1) awarding points to members based on a rating of their respective rankings received in step (c2). In one form of this embodiment, the method further comprises the steps of awarding a predetermined number of points, C1,¹ if the member's top-ranked implementation was also among the top Q1 aggregate choices of the other members who reviewed this implementation. In another form, the method further the steps of awarding a fixed number, C2, of points, if the member's top choice was also among the top Q2 aggregate choices of the evaluators. In one embodiment, these points are termed survival points and are used to evaluate and determine a particular member's further participation in the collaboration.

¹Italicized characters refer to predetermined positive integers.

### DESCRIPTION OF THE DRAWINGS

FIG. 1 is a functional block diagram illustrating an embodiment of the present invention.

FIG. 2 is a functional block diagram illustrating an apparatus according to an embodiment of the present invention.

FIG. 3 is a flow chart setting forth a method according to one embodiment of the present invention.

### DESCRIPTION OF PREFERRED EMBODIMENT(S)

I. Exemplary Operating Environment

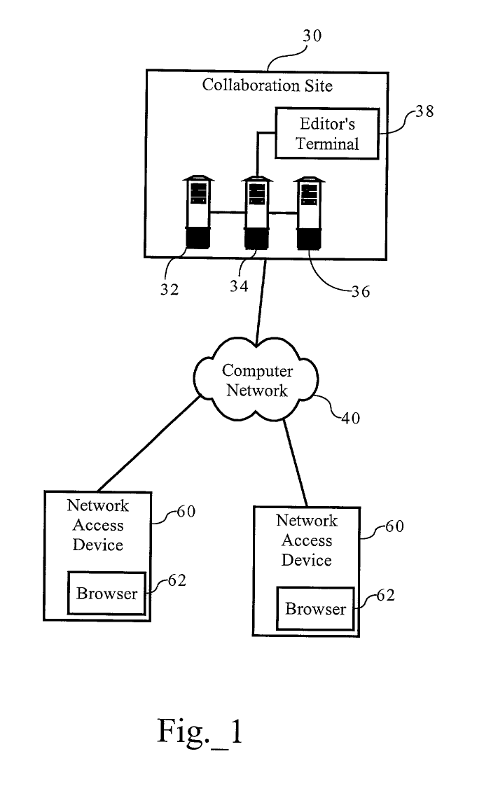

FIG. 1 illustrates an embodiment of the present invention as applied to computer network 40. Computer network 40 can be any suitable computer network, including an open, wide-area network, such as the Internet, a local-area network, and/or a combination thereof. In addition, computer network 40 can comprise an electronic network, an optical network, a wireless network, and/or a combination thereof. As FIG. 1 shows, one embodiment of the present invention operates in a computer network environment comprising collaboration site 30 and at least one network access device 60 associated with one or more users.

A. Collaboration Site

Collaboration site 30 manages the collaborative process in which users, at network access devices 60, participate. In one embodiment, collaboration site 30 is a web site comprising web server 32, application server 34 and database server 36. Web server 32 receives requests for files or other data over computer network 40 and passes them to application server 34. In one embodiment, web server 32 transmits data to users and other sites using the SSL (“Secure Sockets Layer”) encryption protocol, the S-HTTP (“Secure HTTP”) protocol, or any other similar protocol for transmitting confidential or private information over an open computer network. In one embodiment, database server 36 stores content and other data relating to the operation of the system. Application server 34, according to one embodiment, accesses database server 36 and generates pages or other files that web server 32 transmits over computer network 40 to the intended recipient. In addition, although only a single web server 32, application server 34 and database server 36 are illustrated, the functionality described herein can be distributed among a plurality of servers or, in the alternative, implemented on a single server.

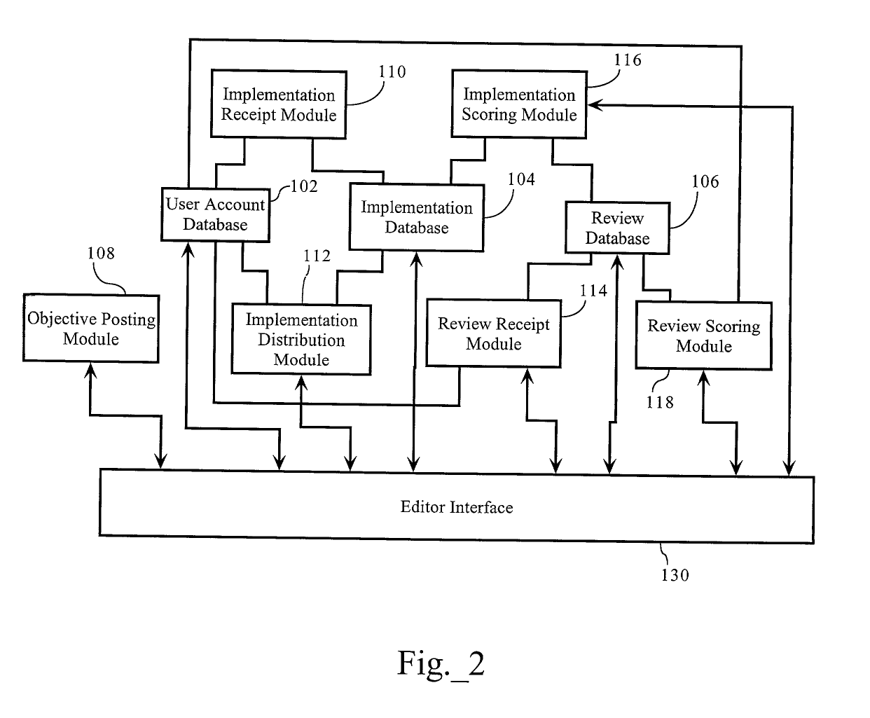

In one embodiment, database server 36 includes user account database 102, implementation database 104, and review database 106 (see FIG. 2). User account database 102 stores data related to user accounts in association with a user identification. In one form, such data includes a password (for authentication and control of access to each user account) and an email address allowing the user to receive notices and other data. In one form, user account data also includes data relating to the project(s) in which respective users currently participate. As to each project, user account database 102, in one embodiment, includes the number of points awarded to a user, the user's submission history, and a reviewer history. In one embodiment where users are eliminated as the collaboration progresses (see below), user account data further includes a status flag for each project indicating whether a user is active or inactive. In one form, submission histories include pointers to submitted implementations stored in implementation database 104 and scores, if any, for the submitted implementations. Reviewer histories include a pointer to a review stored in review database 106 and scores for each review, if any.

Implementation database 104 stores implementations submitted by users over computer network 40. In one embodiment, each submitted implementation in implementation database 104 has associated therewith an implementation identification, a project identification, a user identification, an aggregate score, and a submission time stamp. Similarly, review database 106 stores reviews of implementations submitted by users over computer network 40. Review database 106 stores each review in association with a review identification and a project identification.

In one embodiment, application server 34 includes objective posting module 108, implementation receipt module 110, implementation distribution module 112, review receipt module 114, implementation scoring module 116, review scoring module 118, and editor's interface 130 (see FIG. 2). Objective posting module 108 allows editors to post objectives for viewing by a plurality of users over computer network 40. In one embodiment, objective posting module 108 is operable to actively transmit objectives to various users via e-mail, instant messaging, or similar techniques. Implementation receipt module 114 receives proposed implementations from users over computer network 40 and stores them in implementation database 104. Implementation distribution module 112 selects users to review and score a subset of the implementations corresponding to a particular objective and, in one embodiment, is operable to transmit such implementations to corresponding users. Review receipt module 114 is operable to receive reviews of implementations from users and store them in review database 106. Implementation scoring module 116, based on the reviews stored in database 106, scores implementations and stores the score in association with the corresponding implementation. Review scoring module 118 evaluates and scores the reviews submitted by users and stored in review database 106. Editors access the functionality provided by the above-described modules, as well as the data stored in the above-described databases, via editor interface 130. In one embodiment, editor interface 130 further includes application programming interfaces allowing for the development of additional functionality based on the above-described modules and data.

B. Network Access Device

Users access collaboration site 30 with a network access device 60, which receives, displays and transmits data over a computer network. In one embodiment, a network access device is a browser 62 executed on a personal computer, a browser 62 executed on a network computer, or a browser on a cell phone or personal digital assistant. However, any suitable device and/or application for accessing and displaying data transmitted over a computer network can be used.

One embodiment of the user interface is implemented using page-based interfaces transmitted to a conventional computer having an Internet browser and a connection to the Internet 40. The user's computer can be any computer, special-purpose computing device, or any other suitable device for performing the required functionality. In one embodiment, user computer includes at least one processor, a data storage system (including volatile and non-volatile media), a keyboard, a display, at least one input device and at least one output device. In one embodiment, the user's computer is connected to the Internet via a modem dial-up connection or through a network line. Such communication, however, could also be wireless. In addition, although embodiments of the system are described as working in conjunction with a browser, any suitable device or application for receiving, displaying and transmitting data over a computer network can be used with the present invention.

II. Operation of Exemplary Embodiments of the Present Invention

The present invention can be applied to almost any creative and/or functional endeavor and allows for myriad forms of large-scale collaboration involving a community of incentivized users. The illustrative embodiments provided below are examples of the breadth of possibilities for implementation of the present invention. For example, the present invention can be used in a “one-pass” implementation involving only one round of implementation submissions, review and scoring, or in a “multiple-pass” implementation involving iterative rounds of objective posting, implementation submissions, review and scoring.

A. Collaborative Development of a Script

In one embodiment, the present invention can be employed to incentivize the collaborative creation of a screen play among a plurality of users. In one embodiment, the process flow is best understood as a sequence of steps that are cyclically repeated. The participants in the process are Internet users (“members”) who have registered with and possess user accounts at collaboration site 30. In one embodiment, the participants also include creative staff (“editors”) who are employees of collaboration site 30 that manage and/or control the collaborative process, as more fully described below. A “segment” refers to a sequential piece of a screenplay which has a specific objective, such that any screenplay can be described as a finite sequence of segments. In one embodiment, a master list of objectives is compiled by the editors before the process begins. Each kind of objective is associated with its own standard form. Over the course of the collaboration, these forms are sequentially displayed to members on collaboration site 30, as each of the objectives are posted by the editors using objective posting module 108.

In one embodiment, in the first segment of a script, all members have access to participate (assuming they provide the password associated with their account during an authentication phase), but in subsequent segments, progressively fewer members are allowed access. An embodiment of a method for this particular embodiment follows:

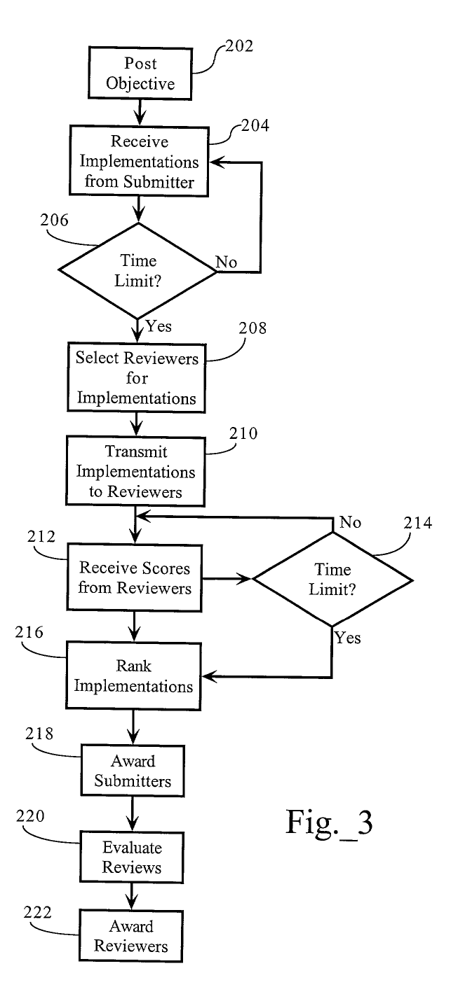

A new segment begins by having an objective chosen for it by the editor staff. For example, and in one embodiment, the objective can be the introduction of a new character, a plot twist, or a description of the background elements of a particular scene. The form which corresponds to the chosen objective is posted onto the Internet (see FIG. 3, step 202). Members, at network access devices 60, log on to collaboration site 30, provide a password for authentication, and select the project on which they wish to collaborate. In one embodiment, application server 32 access user account database 102 to determine whether member has access privileges to the selected project. In one embodiment, if the project status flag is set to “active,” the user is allowed access to the objective and may submit an implementation. In one embodiment, collaboration site 30 transmits a form to members explaining the current objective and instructing members to enter an implementation for the objective into the form and submit it.

In one form, implementation receipt module 110 receives the implementations from users over computer network 40 (FIG. 3, step 204) and stores them in implementation database 104 in association with the corresponding user identification and a project identification, in embodiments where collaboration site 30 supports multiple concurrent and/or successive projects. In one embodiment, a pointer to the implementation stored in implementation database 104 is added to the user's account. After a predefined length of time (see FIG. 3, step 206), implementation receipt module 110 no longer accepts implementation submissions for the segment.

Implementation distribution module 112 then selects participating members (“reviewers”) to review each implementation (FIG. 3, step 208) and transmits the implementations to the selected reviewers for evaluation and scoring (step 210). In one embodiment, each implementation submission is sent to a certain fixed number, n, of randomly chosen participating and/or active members. In one form, the randomization is such that no member receives his or her own submission. The implementations can be distributed to reviewers in a variety of ways. In one form, the implementations are transmitted in an e-mail or as attachments to an e-mail. In another form, collaboration site 30 transmits an e-mail to participating members inviting them to log on and receive the implementations for evaluation and scoring. In another form, collaboration site 30 places the onus on participating members to periodically log on to collaboration site 30 and check the status of the project and determine if any implementations must be reviewed.

The implementations can be scored in a variety of ways. In one embodiment, each reviewer evaluates the implementations and provides an absolute score, grade or rating to each implementation. In another embodiment, each reviewer evaluates the implementation submissions which are sent to them by ranking their top T choices. In one embodiment, review receipt module 114 receives the reviews from the reviewers (FIG. 3, step 212) and stores them in review database 106 in association with respective user identifications and, in some embodiments, project identifications. In one form, review submissions also have a deadline and will not be recorded after such deadline (see FIG. 3, step 214).

After the review submission deadline, implementation scoring module 116 aggregates the reviewer scores and ranks the submissions according to their aggregate score (see FIG. 3, step 216). In one embodiment, implementation scoring module 116 aggregates the reviewer rankings and ranks the submissions according to their aggregate rankings among reviewers. This ranked list, in one form, facilitates the editor's review and evaluation process. In one embodiment, the implementation submission having the highest ranking is selected as the winning submission. In another embodiment, the editors review only m submissions with the best aggregate reviewer ranking. In one form, each editor in the staff evaluates the m submissions by ranking their top E choices. A winning submission is selected as the one with the best aggregate editor ranking. Ties are broken by iteratively repeating the rankings of submissions by staff editors, restricted to submissions tied for the best ranking. The winning submission is appended to the script.

Collaboration site 30 then rewards members based on the scoring and/or ultimate use of their respective submissions (FIG. 3, step 218). In one embodiment, a total of P points are distributed to the writer of the winning submission. In one embodiment, the editors may choose to combine elements of their top H choices into a hybrid selection, in which case the P points are distributed pro-rata to the relevant contributors. According to one embodiment, the editors must distribute P points in total to the winning entries for each segment. In one embodiment, the awarded points are recorded in corresponding user accounts in user account database 102. In one form, the points awarded are project-specific. In one embodiment, points are also awarded to members based on the resulting rankings of the implementation submissions, whether or not, they are selected or used by the editors. For example and in one embodiment, the submitters of the top x ranked submissions are awarded a predetermined number of points.

Collaboration site 30 also evaluates the quality of the peer review (FIG. 3, step 220) and further awards points to reviewers based on the evaluation of their respective reviews (step 222). In one embodiment, review scoring module 118 distributes points to reviewers based on the quality of their critical judgement, as follows: A) If a reviewer's top choice was also among the top Q1 aggregate choices of the other members who reviewed this choice, then the member will receive a fixed number, C1, of points; and B) If a member's top choice was also among the top Q2 aggregate choices of the editors, then the member will receive a fixed number, C2, of points.

In one embodiment, collaboration site 30, after each round of a project, eliminates a predetermined number/fraction of members based on the number of points each member has accumulated. In one form, collaboration site applies a mathematical algorithm to eliminate a certain fraction, F, of the members with the lowest total number of points. In one embodiment, if the eliminated fraction is too large due to ties, a commensurate number of the eliminated members will be reinstated on a random basis. Eliminated members may no longer continue to contribute to this script. In one form, the status flag of an eliminated member's user account is set to “inactive.” In one embodiment, however, eliminated members are allowed to keep the number of points they have accumulated thus far. Eliminated members are also allowed to participate in other scripts or projects that are being developed concurrently on collaboration site 30, provided they have not already been eliminated from those as well.

In one embodiment, the above-described process is repeated until the editors deem that the script has ended. In one embodiment, a certain number of the members from the final segment will be allowed to participate in a chat-based refinement of the script along with the editors. Such members may accrue additional points as a result of their participation in this process. In one embodiment, when the script is finalized, it may either be sold or produced by the company running collaboration site 30.

According to one embodiment, members are awarded equity in the resulting work according to the number of points awarded. In one embodiment, equity is awarded based on equity points. In one embodiment, each member, then shares in the revenues generated by the work according to the amount of equity allocated to him or her. In one form, any profits that result from the sale of the script or the distribution of a produced script will be shared in some proportion Z with the members who contributed to the development of the script. In one embodiment, the formula for determining a member's revenue-sharing fraction is Z*Y, where Y is the percentage of total points awarded for the script that are owned by the member. In one embodiment, a certain number of the top contributors (by point total) will receive writing credits on the script.

The embodiment described above accommodates many versions, refinements, alternatives, and permutations. However, certain aspects of the overall invention and/or the particular embodiment described above are listed below:

1. A script is broken down into manageable objects. In the embodiment described above, the objects are called segments. In other implementations, the objects may be any combination of subplots, characters, or other story elements.

2. The process for developing the work and objects is iterative and cyclical, and involves the creative and critical participation of members over the Internet or other computer network.

3. The members have incentive to participate in the creative development of the script.

4. The creative process is centrally managed and intermediated.

5. The selection of creative material for inclusion in the script is determined by a fair, critical process that involves large-scale peer review.

6. The members have incentive to contribute to the success of the peer review process.

7. The critical process is centrally managed and intermediated.

8. The incentive to participate is both financial (due to revenue sharing), and non-financial (due to the awarding of credits).

9. The process is scalable and capable of parallel implementations, meaning that many scripts that invoke the procedure may be developed simultaneously.

10. The quality of peer review (on the basis of point total) increases monotonically with each iteration of the process.

11. The progressively smaller number of members that has access to the script also receives a progressively larger equity stake in the script, which provides a strong disincentive for members to attempt to steal the intellectual property of the membership and company.

12. The resulting intellectual property is also protected by the fact that there is a public record of the development of the script, as well as a log of all individuals who contributed and had access to the script at every segment.

B. Enhancement of Web Site using Collaborative Tools

One embodiment of the present invention facilitates the enhancement of a web site through collaboration among users. For example, and in one embodiment, collaboration site 30 is a financial investment web site offering various software tools related to investing and finances. In one embodiment, collaboration site 30 posts an objective calling for proposed enhancements to the web site itself or to a particular tool available through the site (FIG. 3, step 202). Members, for example, submit implementations suggesting the addition of a mutual fund performance watch page, a retirement savings calculator, and/or a stock price forecasting tool. After an implementation submission period (steps 204 & 206), collaboration site 30 selects participating members to review the implementations (step 208) and transmits them accordingly (step 210) for review and evaluation. As above, collaboration site 30 receives reviews during a review submission period (steps 212 & 214) and ranks the implementations based on the reviews (step 216). In one embodiment, after ranking of the implementations, editor interface 130 presents the top m ranked implementations for review and consideration by the editors. The editors select the winning implementation(s); points are awarded to the submitters (step 218). Review scoring module 118 evaluates the reviews and awards points to the reviewers (steps 220 and 222).

The editors of collaboration site 30, in a “one-pass” model, execute on the winning implementation without further collaboration from the members, or, in a “multiple pass” model, create and post an objective directed to refinements or more details for the winning implementation for further collaborative development. For example, assuming that the stock price forecasting tool was selected as the winning implementation, the editors can post, for example, an objective calling for the desired features of such a tool.

Unlike the script embodiment above where points determine a proportional share of revenues, points awarded in this embodiment can be redeemed for prizes, such as a free month/year membership to collaboration site 30. In one embodiment, points are redeemable in an on-line store associated with collaboration site 30. In one embodiment, points may be redeemed for gifts or gift certificates, airline miles, or any other suitable prize or reward.

C. Achieving Objective of Focus Groups

One embodiment of the present invention can be used in marketing and/or product development. One embodiment achieves the objectives of a focus group by limiting participation in the collaboration to members meeting certain qualifications (e.g., age, gender, professional degree, etc.). For example, assume that a pharmaceutical company develops a new chemical or drug having use in the treatment of three different health-related problems (e.g., heart disease, erectile dysfunction, and hair loss). The pharmaceutical company can use the present invention to develop a marketing strategy through a collaboration among participating doctors and physicians. For example, the pharmaceutical company running or sponsoring collaboration site 30 can post an objective explaining the new drug and asking how this new drug should be marketed. Later objectives can include desired product features, such as the desired mode of delivery for the drug (e.g., oral, intravenous, etc.). Members review the objective and submit implementations for review as described above. The process can be iterated to develop a detailed marketing and product development strategy.

The present invention can also be used to incentivize quality reviews of products. For example, collaboration site 30 can post an objective to review a certain product. Users submit product reviews for review and evaluation by the community of users. Points are awarded to the submitter of the winning submission, which is used as the posted review of the product, and to other users based on the quality of their peer review.

What is claimed is:

1. A method for facilitating the collaborative creation of a work among users over a computer network, comprising the steps of
(a) posting an objective for a work on a server operably connected to the computer network;
(b) receiving implementations of the objective from users over the computer network;
(c) transmitting implementations received in step (b) to users for review and scoring;
(d) receiving scores of the implementations from a plurality of users;
(e) ranking the implementations based on the scores received in step (d);
(f) evaluating the review performance of users based on the scores received in step (d) and the ranking step (e); and
(g) rewarding at least one user based on the evaluation of the corresponding review performance in step (f).

2. The method of claim 1 further comprising the step of
(h) rewarding at least one user based on the ranking of implementations of step (e).

3. The method of claim 1 or 2 further comprising the steps of
(i) considering the first n ranked implementations from step (e);
(j) selecting one of said first n ranked implementations.

4. The method of claim 3 further comprising the step of
(k) rewarding the user corresponding to the implementation selected in step (j).

5. The method of claim 1 wherein the rewarding step comprises
(g1) awarding points to users based on the evaluation of the corresponding review performance in step (f).

6. The method of claim 5 wherein the points are operable to determine the equity stake of the user in the work.

7. The method of claim 5 wherein the points are redeemable.

8. The method of claim 1 further comprising the steps of:
(h) selecting one of the implementations received in step (b);
(i) posting a second objective associated with the selected implementation;
(k) repeating steps (a)-(g).

9. The method of claim 1 wherein the scores received in step (d) are relative rankings of implementations; and wherein the ranking step (e) comprises the steps of:
(c1) aggregating the rankings; and
(c2) ranking the implementations based on their respective aggregate rankings.

10. The method of claim 3 wherein the selecting step (j) further comprises the steps of
(j1) evaluating, among at least two internal evaluators, the implementations having the highest aggregate ranking of step calculated in step (c3);
(j2) ranking the highest scoring implementations; and
(j3) aggregating the rankings.

11. The method of claim 10 wherein the selecting step (i) further comprises the steps of (j4) repeating steps (j1)-(j3) until one implementation is accorded the highest aggregate ranking.

12. The method of claim 1 wherein the objective relates to a segment of the work.

13. The method of claim 1 wherein the transmitting step (c) comprises the steps of
(c1) for each implementation, randomly selecting a predetermined number of users; and,
(c2) transmitting the implementations to the users randomly selected in step (c1).

14. The method of claim 13 wherein the random selecting step (c) is performed such that no user receives his own implementation.

15. The method of claim 5, 6 or 7 wherein the points awarded are survival points.

16. The method of claim 15 further comprising the steps of:
(h) eliminating at least one member from further participation in the collaboration, said at least one member having the least number of total survival points.

17. The method of claim 1, further comprising the step of:
(i) repeating steps (a)-(g) a desired number of times.

18. The method of claim 1, further comprising the step of:
(i) repeating steps (a)-(g) until the work is completed.

19. A method for facilitating the collaborative creation of a work among users over a computer network, the method comprising the steps of
(a) posting an objective on a server operably connected to the computer network;
(b) receiving implementations of the objective from the users over the computer network;
(c) scoring the implementations;
(d) selecting the implementation having the greatest score;
(e) adding the implementation to the work; and,
(f) awarding points to at least one user based on the scoring step (c).

20. The method of claim 19 wherein the objective is posted in a form which users complete and transmit back.

21. The method of claim 19 wherein the objective relates to a segment of the work.

22. The method of claim 19 wherein the scoring step (c) comprises the steps of:
(c1) transmitting implementations to at least two of the users;
(c2) receiving a ranking of the implementations from each of the users who received the implementations in step (cl); and
(c3) aggregating the rankings.

23. The method of claim 22 wherein the scoring step (c) further comprises the steps of
(c4) evaluating, among at least two internal evaluators, the implementations having the highest aggregate ranking of step calculated in step (c3);
(c5) ranking the highest scoring implementations; and
(c6) aggregating the rankings.

24. The method of claim 23 wherein the scoring step (c) further comprises the steps of
(c7) repeating steps (c5) and (c6) until one implementation is accorded the highest aggregate ranking.

25. The method of claim 19 wherein the awarding step (f) comprises
(f1) awarding a predetermined number of points to the user having submitted the implementation selected in step (d).

26. The method of claim 22 wherein the awarding step (f) comprises
(f1) awarding a predetermined number of points to the user having submitted the implementation selected in step (d).

27. The method of claim 23 or 26, wherein the awarding step (f) further comprising the steps of:
(f2) awarding points to users based on a rating of their respective rankings received in step (c2).

28. The method of claim 27 wherein the points awarded in step (g) are survival points.

29. The method of claim 19, further comprising the steps of:
(h) eliminating at least one user from further participation in the collaboration, said at least one user having the least number of total points.

30. The method of claim 29, further comprising the step of:
(i) repeating steps (a)-(h) a desired number of times.

31. The method of claim 29, further comprising the step of:
(i) repeating steps (a)-(h) until the work is completed.

32. The method of claim 30 or 31, further comprising the step of:
(j) allocating equity in the work to the users according to their respective points.

33. The method of claim 28, further comprising the steps of:
(h) eliminating at least one user from further participation in the collaboration, said at least one user having the least number of total survival points.

34. An apparatus facilitating collaborative development of works among users over a computer network, comprising:
an implementation database,
a review database, and
a server operably connected to the computer network, the server comprising:
an objective posting module operable to facilitate the posting of objectives on the server, the objectives being accessible to a plurality of users at network access devices operably connected to the computer network,
an implementation receipt module operable to receive implementations submitted by users over the computer network and store them in the implementation database,
an implementation distribution module operable to transmit implementations stored in the implementation database to a plurality of users,
a review receipt module operable to receive reviews of implementations submitted by users over the computer network and to store the reviews in review database in association with corresponding implementations,
an implementation scoring module operable to score implementations based on corresponding reviews, and
a review scoring module operable to score reviews based on an aggregation of associated reviews stored in the review database.

35. The apparatus of claim 34 further comprising an editor interface operable to display the highest ranking implementations.

36. The apparatus of claim 34 or 35 wherein the reviews stored in review database are relative rankings of a plurality of implementations.

37. The apparatus of claim 36 wherein the scoring implementation module aggregates the reviews submitted by users to compute an aggregate ranking of each implementation.
